(19) United States
(12) Patent Application Publication
(10) Pub. No.: US 2016/0335724 A1
(43) Pub. Date: Nov. 17, 2016

(54) LIFE-COMPONENTS ORIENTED FINANCIAL PLANNING SYSTEM

(71) Applicant: Siu Cheung Louie Mak, Tuen Mun (HK)

(72) Inventor: Siu Cheung Louie Mak, Tuen Mun (HK)

(21) Appl. No.: 15/222,043

(22) Filed: Jul. 28, 2016

Related U.S. Application Data
(63) Continuation-in-part of application No. 14/356,060, filed on May 2, 2014, now abandoned.

(51) Int. Cl. G06Q 40/06; G06Q 50/00

(52) U.S. Cl. CPC G06Q 40/06; G06Q 50/01

(57) ABSTRACT

A life-components oriented financial planning system comprises a timeline planning interface module for generating an interface comprising a plurality of histograms representing a planning target's “life components”; a projection generation module comprising projection generation formulae, wherein the entire projection data form the projection set of a “life road”; a financial destiny chart module for creating financial destiny charts from projection data in projection sets. Each life component comprises four kinds of “projections”, income, expenses, assets and liabilities. The position and length of the histogram represent values of a corresponding life component. The planning target's life road comprises life components; life components are grouped by financial modules and formed from projections; the projection comprises items. The present invention can strengthen trust in the planning process, making a planning target input more personal data to plan for himself or herself. The status the system simulates becomes clearer as more information is provided.

### CROSS-REFERENCE TO RELATED APPLICATION

This application claims priority to U.S. patent application Ser. No. 14/356,060, filed on May 2, 2014, which is a U.S. national phase filing of PCT/CN2011/081779 filed Nov. 4, 2011, the disclosures of which are hereby incorporated herein by reference in their entireties.

### TECHNICAL FIELD

The present invention relates to a financial planning system built with computer programs or hardware modules, which is based on the concept of “life-components oriented financial planning” for assisting financial planners to establish financial targets and execute financial simulations, or facilitating common people lacking financial expertise to do preliminary financial planning with the present system for themselves.

### BACKGROUND OF THE INVENTION

Personal finance service is a type of business that values “trust” much because 1) financial products are intangible, 2) financial products are promises for the future, 3) both buyers and sellers differ substantially in their respective perceptions of the performance of a financial product, and 4) every relevant decision is generally very important for an individual. Therefore, if both parties cannot build sufficient trust, a deal can hardly be done.

Practitioners in the market generally adopt one of the following four ways to build “trust” for promoting a deal.

The first way is to sell by “relationship”, which means that a buyer purchases a product completely based on his or her trust in the seller. Once upon a time, almost all deals of insurance businesses were done in this way.

The second one is to sell by “product”, namely the purchasing decision of a buyer is dependent on the merits of product. Currently this is a very common way for selling, but it has been negatively impacted by recent incidents such as Lehman Shock and the global financial tsunami.

The third one is to sell by “advice”, which means that a practitioner builds trust through his or her professional status. Currently many institutions in the market are dedicated to promoting this selling approach, but it is yet to be influential due to a number of reasons.

The fourth one is to sell by “procedure”, which means that a deal is done through a procedure in which a customer trusts. This is basically the concept of financial planning procedure, while it is being criticized as too theoretical, it can be practically applied with the support of suitable information technology.

Chinese invention patent application CN201010149245.2 (publication number CN101877108A) provides a personal finance services center system based and built on a fundamental platform of internet banking, wherein the personal finance services center comprises a financial planning module for providing details of financial planning; a banking business module for providing conventional banking businesses; an investment center module for providing customer investment tools; a family financial management module for providing family expenses data; a report center module for generating reports for getting acquainted with data on personal assets and liabilities; a financial planning information station module for publishing different financial information and articles on financial planning and for introducing financial planning products; a financial management toolbox for providing calculation gadgets; and a “My Advisor” module for generating tailor-made financial planning proposals. The advantageous effect of the invention is that it supports personal investment and finance management services, and thus facilitates the execution of investment and financial management on internet banking for individuals.

Chinese invention patent application CN200910158349.7 (publication number CN101916424A) provides a family financial health checking model and system, which is a business model for internet industry realized by using information technology. The family financial health checking model uses a software system to comprehensively evaluate the personal financial health or family financial health of a customer according to a total of 27 financial health checking indicators in five categories, namely family consumption management, family protection management, financial planning management, asset allocation management, and investment management, whereby creating a new service model in the financial management business by which complex family financial planning issues are systematically sorted out and analyzed, hidden financial problems of the customer can be detected in time, and bad financial habits can be corrected so as to enhance the resistance of the customer against the ups and downs of the financial market and increase the income of the customer from property. At the same time, the family financial data of the customer can be very conveniently checked by using such model, whereby remarkably improving the working efficiency of financial planner.

The foregoing two patent applications of the prior art can be respectively categorized as selling by “advice” or selling by “procedure” as mentioned hereinbefore.

The drawbacks of similar products of the prior art are:
1. The financial management system adopts a number input method comprising mainly questionnaires in the form of a financial report.
2. If a customer refuses to disclose financial information, financial planning cannot be started.
3. Information of the customer can only be input into a financial management system unilaterally; there can be no interactions between the financial planning system and the customer.
4. The financial management system can only execute a linear planning process.
5. A customer can hardly understand the rationale behind the advice given by the financial management system.
6. The technical superiority of the financial management system is mainly in analysis and preparation of financial planning reports.

Therefore, there is a need in the art for a new financial planning solution capable of enhancing customer trust. The value lies wherever the trust is!

### SUMMARY OF THE INVENTION

An object of the present invention is to provide a new financial planning system that can enhance the trust of a planning target in financial planning.

To achieve the aforementioned object, the present invention provides a life-components oriented financial planning system comprising a timeline planning interface module for generating a timeline planning interface comprising a plurality of histograms representing life components of a planning target, wherein the timeline planning interface represents a life road or a roadmap of the planning target, and the life components refer to people and events occurred in financial association with and during lifetime of the planning target; a projection generation module comprising projection generation formulae for calculating projection data, wherein entirety of the projection data form a projection set of the “life road”; a financial destiny chart module used for creating financial destiny charts from projection data in the projection set and performing status analysis and/or projection analysis, wherein the financial destiny charts comprise life financial statements and financial relationships charts; wherein each “life component” comprises four kinds of “projections” comprising income, expenses, assets and liabilities, and position and length of the histogram in the timeline planning interface represent a value of a corresponding life component in a life component mode or a projection mode; wherein the “life road” of the planning target comprises “life components”; “life components” are grouped together by “financial modules” and are formed from “projections”; details of the “projection” comprise “items”; and entire financial life of the planning target is structurally divided into four categories: “the life road”, “the life component”, “the projection” and “the item”.

The “life-components oriented financial planning system” of the present invention adopts a new, interactive and humanized life component input mode to execute the entire planning process. In the planning process, the more information provided by a customer (i.e. planning target), the clearer the status simulated by the system. The customer may experience first the benefits of the financial planning process, so as to be encouraged by and gain more trust in the system of the present invention, and eventually input more personal data to do own planning.

### BRIEF DESCRIPTION OF THE DRAWINGS

FIG. 1 is a schematic view of the timeline planning interface in the “life-components oriented financial planning system” of the present invention.

FIG. 2 is a schematic view of basic combinations of life components and financial modules in the “life-components oriented financial planning system” of the present invention.

FIG. 3 is a schematic view of the structure of a life component in the “life-components oriented financial planning system” of the present invention.

FIG. 4 is a schematic view of a life balance sheet in the “life-components oriented financial planning system” of the present invention.

FIG. 5 is a schematic view of financial relationships in the “life-components oriented financial planning system” of the present invention.

FIG. 6 is a schematic view of a life equalizer in the life component mode in the “life-components oriented financial planning system” of the present invention.

FIG. 7 is a schematic view of structures and flows in the “life-components oriented financial planning system” of the present invention.

FIG. 8 is a schematic view of the structure of the system and technical operations in the “life-components oriented financial planning system” of the present invention.

FIG. 9 is a schematic view showing a financial relationship diagram by social relationship of the present invention.

### DETAILED DESCRIPTION OF THE PREFERRED EMBODIMENTS

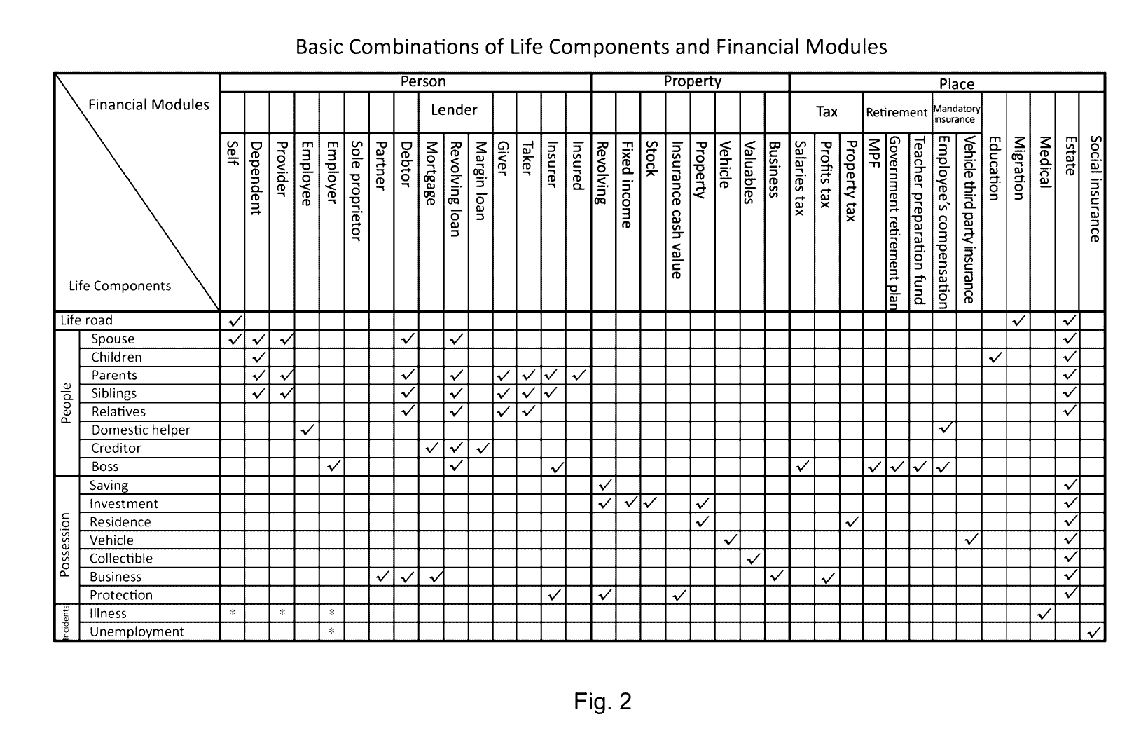

The “life-components oriented financial planning system” of the present invention adopts a new, interactive and humanized life component input mode to execute the entire planning process, instead of the conventional numeric input mode comprising mainly questionnaires in the form of a financial report. Basically, by combining different “life components”, the “life-components oriented financial planning system” of the present invention simulates the financial status of a person's entire life, and based on the simulation results, establishes and outlines his or her personal financial status. “Life components” refer to people and events with which a person has financial relationships during his or her lifetime. See FIG. 2 for basic combinations of different “life components” and their corresponding financial modules.

The first group of “life components” is people (namely person, human being). The most basic “life component” is the “planning target” per se. This “life component” includes the own basic expenses of the “planning target” and related responsibilities of the “planning target.” The “planning target” can even be the only “life component” of the entire life of the “planning target.” Another “life component” is called as “boss”, which refers to personal job income related to the job the “planning target” is employed to do and the relevant expenses, such as tax and mandatory provident fund (in the case of Hong Kong) or public accumulation fund (in the case of mainland China). With just these two “life components”, the “life-components oriented financial planning system” of the present invention can roughly outline the basic financial status of a person such as a young person.

Other life components are people around the “planning target”, including spouse, children, parents, etc., and they will respectively form different financial relationships with the “planning target.” A “depending” financial relationship refers to related living expenses of an adult (e.g. housewife or parents) dependent on the “planning target” or expenses brought by such adult to the “planning target.” With regard to a “maintaining” financial relationship, it means the income the “planning target” gains from his or her provider. A “liability” financial relationship means a debtor of the “planning target”; a “credit” financial relationship means a person who has lent money to the “planning target.”

Another group of “life components” is personal assets, including currency assets, securities and financial assets, life insurance, tangible assets and business assets. The configurations of these “life components” are designed according to the respective characteristics of assets. Even if assets include loans such as home mortgage and collateral, the design related to “life components” can cover them.

The last group of “life components” refers to incidents that may occur during the lifetime of the “planning target”, for example illnesses, accidents, winning a lottery (such as Mark Six), recession, etc. These “life components” outline their corresponding income and expenses as well as their effects on the original personal financial status, and can also be used as a type of stress test simulating the occurrence of one or several “incidents” to test the financial tolerance of the “planning target” and/or find out possible effects on the “planning target.”

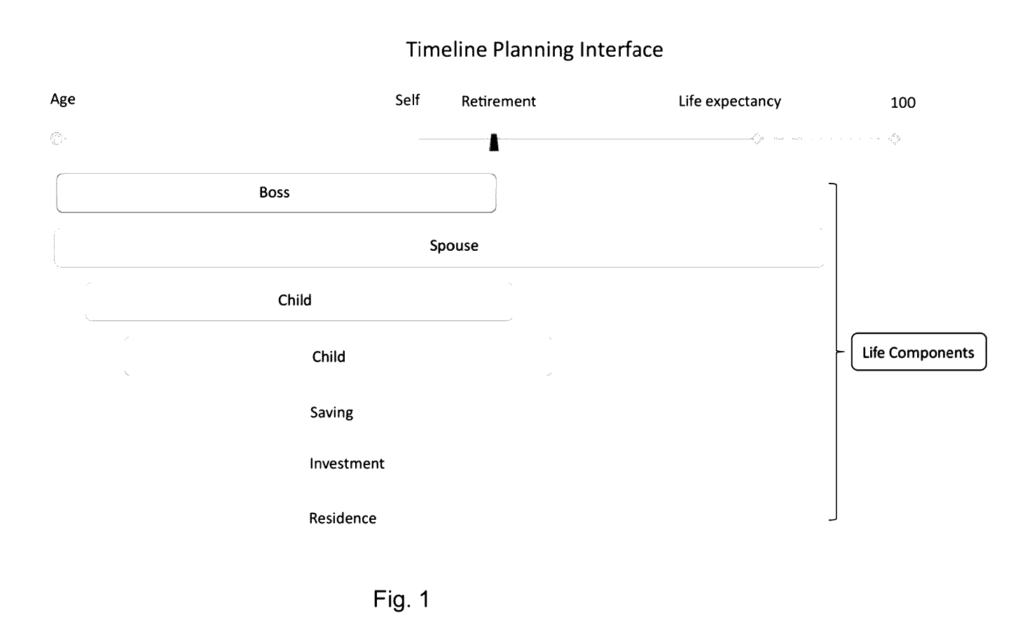

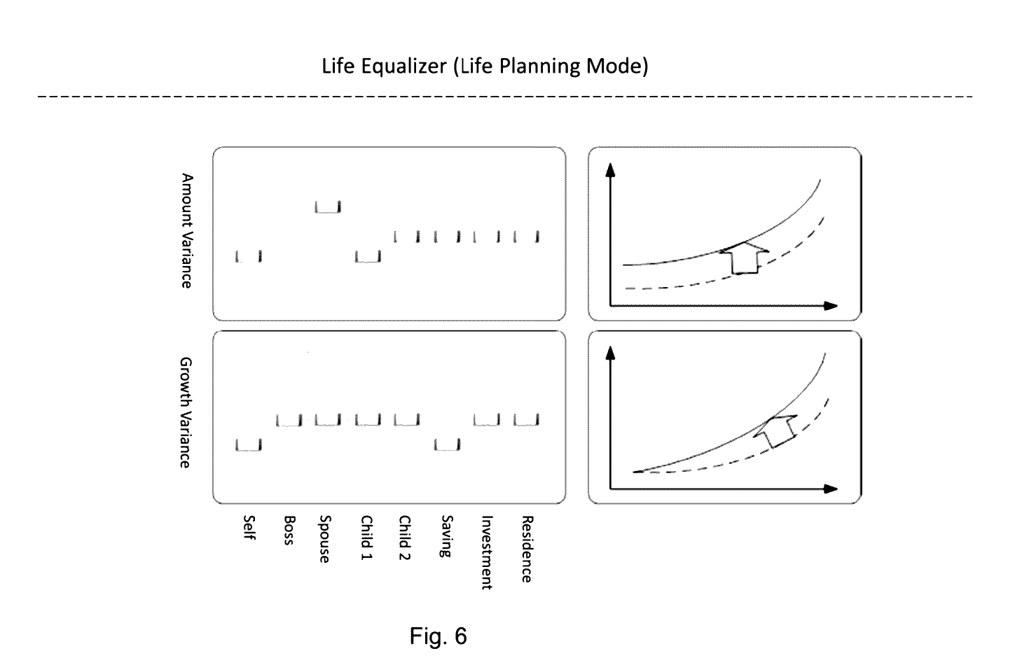

The planning process of the system of the present invention can be very simple. What is needed to do is just drag and drop different “life components” onto the course of life (the timeline planning interface) of a “planning target.” As shown in FIG. 1, in the timeline planning interface, “life components” are represented in the form of a histogram, and a user can freely move the bars and adjust their length according to his or her actual situation or expected situation to illustrate each “life component.” Moreover, a “life component” has several parameters, which a user can adjust according to his or her own situation. The planning target can choose to input numbers, or can visually adjust “life components” in the “life equalizer” shown in FIG. 6. A stress test can also be conducted in the “life equalizer.”

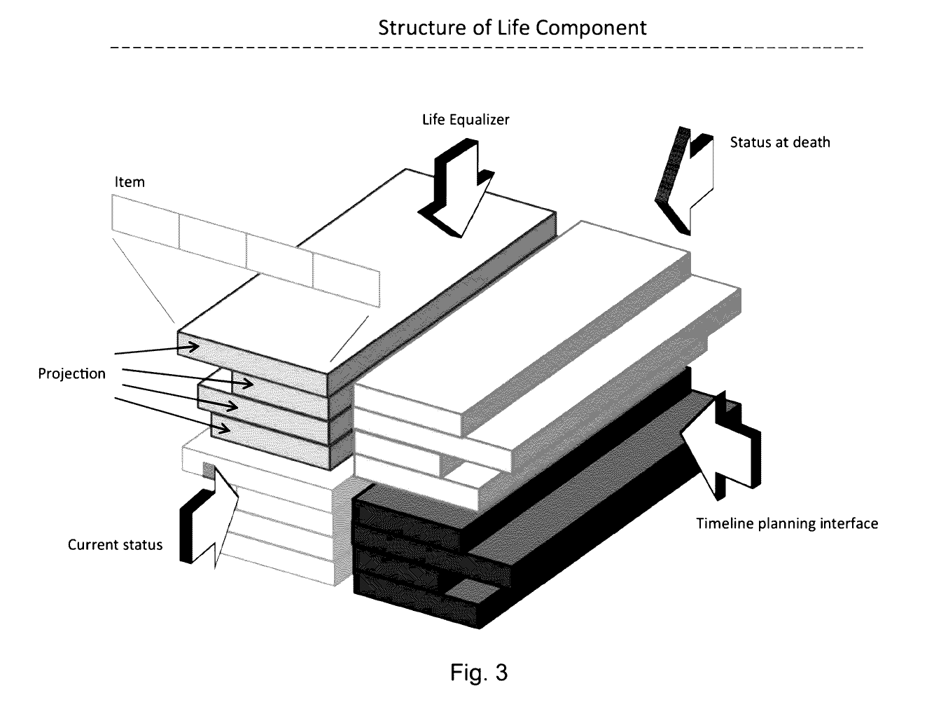

As shown in FIG. 3, each “life component” comprises four “projections”, including income, expenses, assets and liabilities. They are shown separately as four quadrants in the bars shown in FIG. 3. In the “projections” related to each “life component”, their structures and numbers are predefined. Each “projection” has embedded formulae according to its functions to generate data series, and can project up to, for instance, the age of 100. The “projections” of each “life component” can be correlated. Moreover, the system of the present invention will sometimes include “projections” that are invisible to a user for ease of calculation. The “projections” of each “life component” are designed beforehand according to characteristics of that “life component”, wherein the number of “projections” cannot be increased or decreased, and no related formulae can be modified.

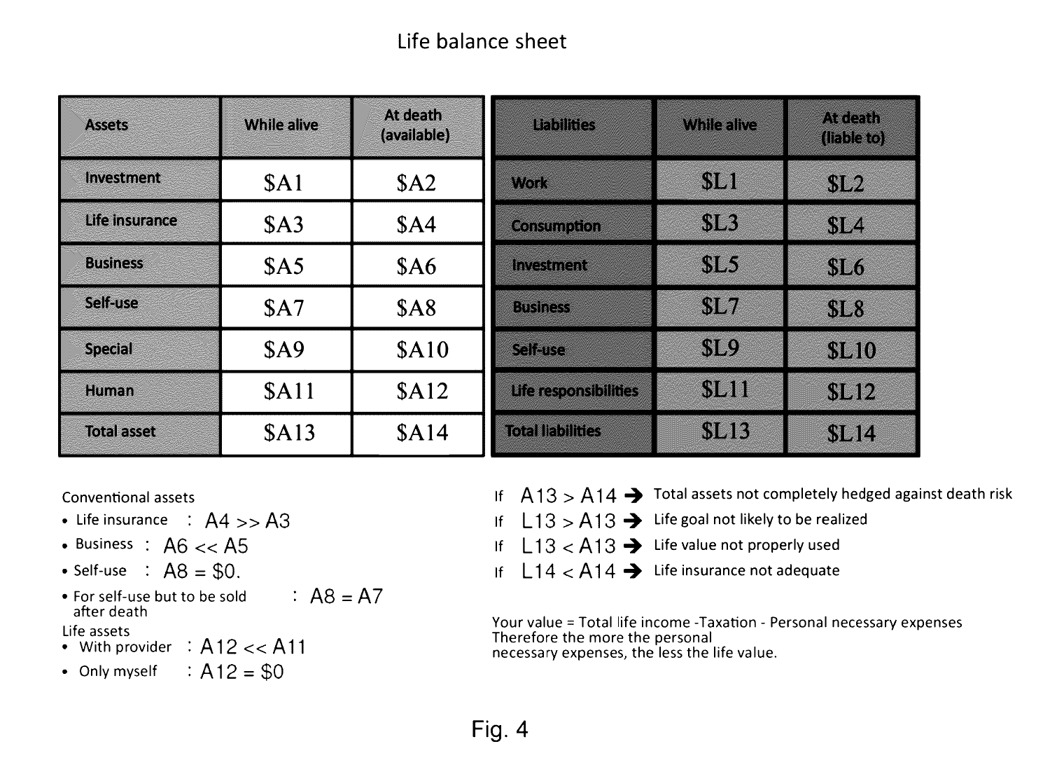

Each value in a “projection” can be calculated from one or several “items.” A user can add “items” to a related “projection” in the “item interface.” There is no limit on the number of items in each “projection.” “Items” can be regarded as details of a “projection”, and an “information retriever” will collect data of that category. All items have no time sequence, and there is no limit on the amount of an item either. After having been completed, the financial status “picture” of a “planning target” can be analyzed by using a number of methods. Among others, the life balance sheet is specially designed to enable a user to clearly understand his or her own current financial status through a single financial report. Unlike the conventional balance sheet, the life balance sheet has special designs comprising human assets, life responsibilities and money amounts at death (see FIG. 4).

Based on the framework described above, the design of the “life-components oriented financial planning system” also possesses modules for market actual data, so that at the start of planning, without referring to actual money amounts, the system of the present invention can use background actual market data to depict a general status for the customer according to qualitative answers of a customer. If the mass of planning targets is sufficiently large, the system of the present invention itself can generate “market data” according to information on planning targets. This is a merit of the Web 2.0 Generation. A customer may first feel the benefits of the financial planning process, and thus he or she will be encouraged to input more personal data to plan for himself or herself.

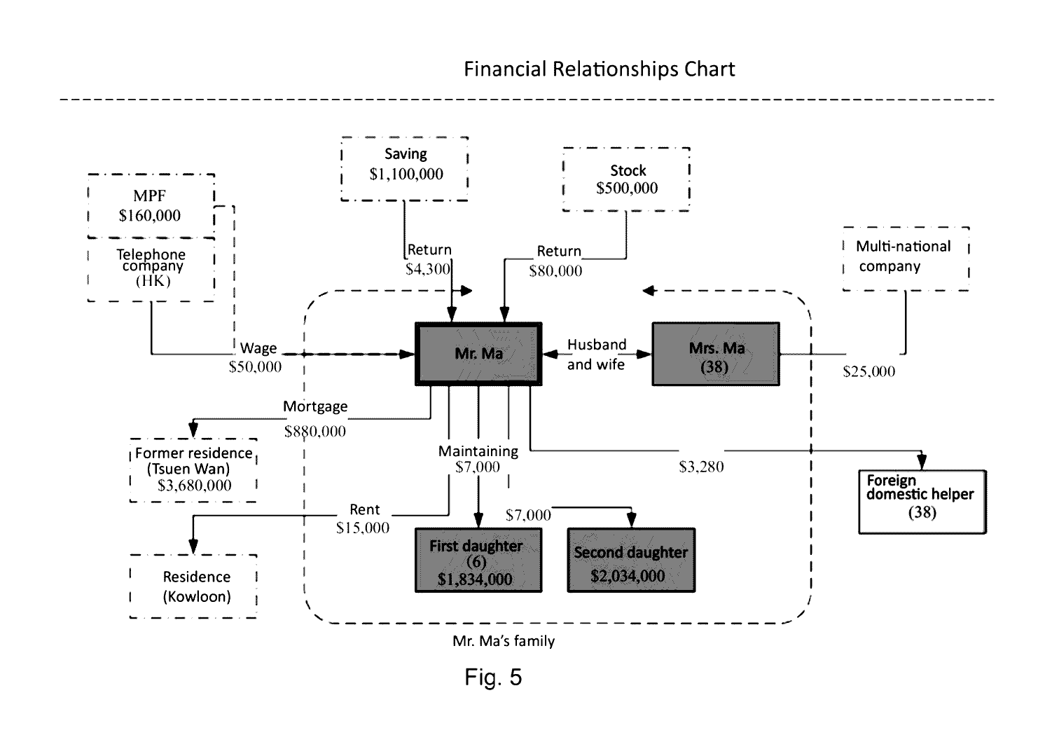

Specifically, the “life-components oriented financial planning system” of the present invention has the following contributive characteristics:
1. Life component template: Unlike other existing designs, the life component template allows a “planning target” to extract from a database a related “life component” template comprising default data values and place it in the “timeline planning interface” to process it first. With this function, without asking a customer for his or her actual financial data, the present invention can preliminarily acquire the general financial status of the customer, i.e. the present invention can create a rather blurred financial picture. This is beneficial in that at the start of financial planning, the customer can feel the benefits of financial planning without disclosing actual financial information.
2. Timeline planning interface: As shown in FIG. 1, this main planning interface enables a planning target to control his or her life goals on a lifetime table by graphical means so as to realize the interactive non-linear planning process. “Life components” in the timeline planning interface can be displayed in the “life component mode” or “projection (details of life component) mode.” As long as a parameter (such as position, length) is not “locked” with another parameter, both modes allow the planning target to drag and drop a “life component” or an individual “projection” to adjust its position and length. A new “life component” can be dragged from the tool bar and then dropped to the timeline planning interface; on the other hand, an unnecessary “life component” can also be deleted or temporarily suspended. With this function, based on a rather blurred and general financial picture (status) created through the life component template, a planning target adds his or her own financial needs to that picture to quickly create a clear financial picture (status) belonging to the user. The picture will become clearer as a customer provides more data.
3. Life equalizer: It is a graphical adjustment interface, allowing a “planning target” to balance his or her life targets by increasing or decreasing parameters of a “financial target” for some percent. In addition to the direct input of numbers, this design allows a planning target to adjust with just a fingertip, similar to the equalizer on a stereo system, as shown in FIG. 6. This function allows a planning target to easily reshape the financial picture or financial status of a customer.
4. Life balance sheet (one of financial reports): As shown in FIG. 4, it is a page of specially designed future financial foundation summary that concisely informs a planning target that whether his or her set life goals match his or her financial resources, whereby the planning target can determine the feasibility and suitability of life goals. Unlike the conventional balance sheet focusing only on conventional assets, this newly designed life balance sheet comprises “human assets” and “life responsibilities”, and the amounts “while alive” and amounts “available/liable to at death” of all items so as to present the comprehensive financial status of a user. Moreover, a user can choose to check the life balance sheet of any year, and use it together with a cash flow projection table to do horizontal analysis.
5. Financial relationships chart: It is a block diagram allowing a user to grasp the relationships between his or her financial status and the people and assets around him or her. FIG. 5 shows an example of the financial relationships chart of the present invention. In FIG. 5, Mr. Ma's family comprises four members in total, Mr. Ma, Mrs. Ma and their two daughters. Their income comprises Mr. Ma's wage, Mrs. Ma's wage, returns from saving and stock (such as interest and dividend); their expenses comprise the mortgage payment for a previously purchased residence, the rent of the current residence, living expenses of the two daughters and the wage of the foreign domestic helper they employ. Through the financial relationships chart in FIG. 5, Mr. Ma's asset relationships can be clearly grasped.
6. Life goal automatization tool: After the status of a “planning target” has been analyzed, this tool, in cooperation with the life equalizer (see FIG. 6), gives suggestions according to target parameters proposed according to the planning target. For instance, it can give a suggestion on the retirement age that suits the financial resources and targets of the planning target.

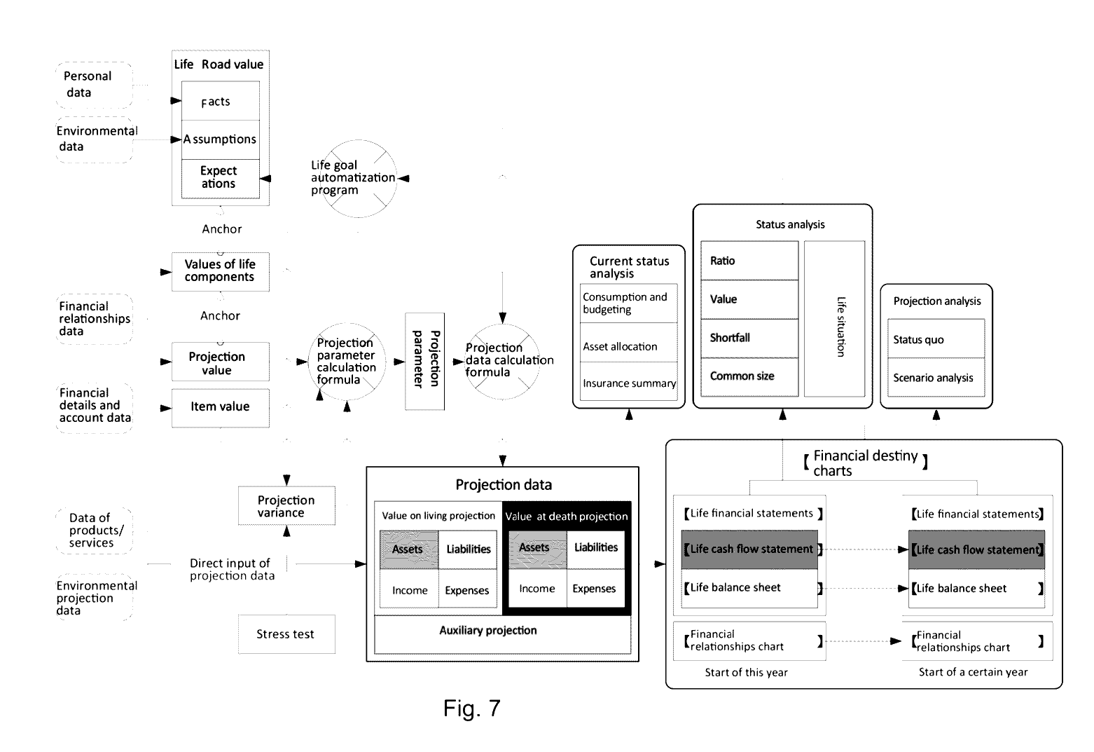

To facilitate a more comprehensive and in-depth understanding of solutions provided by the present invention, mainly according to FIG. 7, the structure and flow of the “life-components oriented financial planning system” or (EOFP, event oriented financial planning system), of the present invention are described below, wherein descriptions of other figures are also inserted.
1) The most basic element in the entire design is “life component” (life component, LC), referring to a person or event with which a person has a financial relationship during his or her lifetime.
2) The target at which the planning process aims is called “planning target.”
3) The entire planning process is to place different “life components” on the “life road” (LR) of a planning target and display them on a timeline. See the timeline planning interface in FIG. 1. In FIG. 1, an axis (timeline) is used to represent the “life road” of a “planning target”, and major milestones of the “planning target”, such as retirement, life expectancy, etc., are listed on the timeline. The length of the timeline (i.e. the life expectancy of the planning target) is usually set at up to the age of 100, and can be set at a longer life expectancy if necessary. Below the timeline, each life component is listed in sequence. The length and position of each life component can generally correspond to the starting time and ending time of that life component on the timeline. See the following description for details.
4) The “life road” of a planning target comprises “life components”; “life components” are grouped by “financial modules” and are formed from “projections”; details of a “projection” comprise “items.” The entire financial life of a “planning target” is structurally divided into four categories:
   a. “life road”
   b. “life component” (grouped by “financial modules”)
   c. “projection”
   d. “item”
5) More than one of the same “life component” can be placed on the “life road”, such as in the case of several “children.”
6) That a certain “life component” appears on the “life road” of a “planning target” indicates that this “life component” has a certain “financial relationship” (FR) with the “planning target” within a certain period of time (i.e. the location and length of that “life component”). In the “financial relationships chart” (FIG. 5), the “financial relationship” is indicated by the amount of money payable to that “life component” or by the amount of money to be collected from that “life component.”
7) “Financial modules” may include but not be limited to the following modules:
   a. Modules related to “person”:
      i. Living consumption,
      ii. Dependency and supporting,
      iii. Credit and debt,
      iv. Sole proprietorship and partnership,
      v. Be employed and employ,
      vi. Give and take,
      vii. Underwriting and insure;
   b. Modules related to “property”:
      i. Sole ownership,
      ii. Joint tenancy,
      iii. Tenants in common;
   c. Modules related to “place”:
      i. National,
      ii. Resident,
      iii. Visitor.
8) “Life components” are divided into three groups. It is not necessary to set up other groups.
   a. The first group is “people.” It is based on social relationships, including but not limited to:
      i. “Spouse”, “children”, “parents”, “siblings”, “domestic helper”, “relative and friend”, “boss”, “company”;
   b. Another group is “possession” (i.e. “planning target's assets”). It is based on the function of a possession, including but not limited to:
      i. “Saving”, “investment”, “housing”, “vehicle”, “valuable”, “business”, “protection”;
   c. The last group is “incidents”, referring to risk or “unexpected events” that may occur, including but not limited to:
      i. “Illness”, “accident”, “unemployment”, “recession”, “winning Mark Six”, etc.
9) All “life components” comprise “financial modules”, which are divided into three types, “person”, “property” and “place” (see explanation in 7. above). As shown in FIG. 2, each “life component” includes certain “financial modules” according to its characteristics.
10) “Financial modules” use various numbers of “projections” (PRJ) of varied characteristics to depict the financial characteristics of the people around a “planning target”, possessions owned by a “planning target”, and places of the possessions in association with the “planning target.”
11) “Financial modules” are only used to form “life components”, and cannot be used directly for planning. Only “life components” formed from “financial modules” can be used directly for planning.
12) FIG. 2 is an example of a detailed chart showing basic combinations of life components and financial modules. In FIG. 2, “√” and “*” indicate correlated life components and financial modules. An actual planning target may have only some of the life components or financial modules shown in FIG. 2, or may have other life components or financial modules not shown in FIG. 2. As shown in FIG. 2, “person” of “financial modules” is classified according to the financial relationship between a “person” and a “planning target”, including but not limited to:
   a. Self (included in the “life road” of a “planning target”),
   b. Dependent and provider,
   c. Creditor and debtor,
   d. Sole proprietor and partner,
   e. Employee and employer,
   f. Giver and taker,
   g. Insurer and insured.
13) “Property” of “financial modules” is classified according to the financial structure of property, including but not limited to:
   a. Revolving,
   b. Fixed income,
   c. Stock,
   d. Insurance cash value,
   e. Real estate,
   f. Vehicle,
   g. Valuables,
   h. Business.
14) “Place” of “financial modules” is classified in accordance with the legislation of the location of a planning target, including but not limited to:
   a. Taxation,
   b. Education,
   c. Retirement,
   d. Mandatory insurance legislation, such as mandatory provident fund or public accumulation fund, third party liability insurance, etc.,
   e. Immigration system,
   f. Medical system,
   g. Estate system,
   h. Social insurance system.
15) The location selected by a “planning target” will change modules related to the “place” of the “financial modules” in the “life road” and “life component.” If the location is Hong Kong, Hong Kong-related “financial modules” of “place” will be incorporated into the “life road” and “life component.”
16) See FIG. 2 for basic combinations of “life components” and “financial modules.”
17) In general, the starting and ending of a “life component” will occur within the “life road” of a “planning target.” In other words, a “financial relationship” occurs within the time of existence of a “planning target.”
18) A certain “life component” and the “life road” start at the same time. This indicates a “financial relationship” already occurred or will occur in this year. For instance, a “planning target” is married or has a child or children.
19) The ending time of a certain “life component” is even later than the ending point of the “life road” of a “planning target.” This indicates that the “financial relationship” related to that “life component” continues even after the “planning target” died at the expected time, such as dependent spouse and children.
20) The occurrence of a certain “event” means a change in “financial relationships” that is indicated by the start, end or length of a “life component.” The event includes but is not limited to the following:
   “Event” “Life component”
   Start of employment Start of “boss”
   Termination of employment End of “boss”
   Change of job End of “boss 1”, start of “boss 2”
   Birth of son/daughter Start of “child”
   Independence of child End of “child”
   Education of child Between start and end of “child” (in general)
   Engagement, marriage Start of “spouse”
   Divorce, death of spouse End of “spouse”
   Purchase of home Start of “residence”
   Change of home Start of “residence 1”, end of “residence 2”
   Inheriting estate of father End of “parent”
21) A “life component” comprises “financial modules”, and a “financial module” comprises “projections” (PRJ) of varied numbers and characteristics. Therefore, a “life component” is, in terms of structure, also “projections” of varied values and characteristics (see FIG. 3). In the structure of the “life component” in FIG. 3, all life components comprise four projections, income, expenses, assets and liabilities, which are placed separately in four quadrants. Each type of projections can include several projections; a projection can include one or several items. The current status of a planning target or the status at the death of a planning target can be obtained by checking the structures of “life components” from different perspectives.
22) A “projection” is a series of data, which is also called “data series.” The number of data is equivalent to the length of one's life. The current design sets the age at 100, meaning that the current design comprises 100 data or data series for 100 years. There can be data series for more than 100 years if necessary
23) A “projection” is divided into two groups: “value on living” and “available at death.” Each group is further divided into four categories: “assets”, “liabilities”, “income” and “expenses” (A. L. I. E.). Thus, there are eight types of projection.
24) The data generation methods or formulae of projections of the same type may not be completely the same. For instance, in the case of the “projection” of “income” of “value on living”, the formula for calculating work income and the one for calculating interest income are different. A formula for generating data is written according to the characteristics of a “financial module.”
25) Different combinations of “projections” generate different financial characteristics of respective “financial modules.”
26) Each “projection” has its own “category” and “label.” See 63) below for details.
27) Each “financial module” has a different combination of “projections” and a different number of “projections.”
28) The number of “projections” and the data generation formula of each “financial module” are fixed in the design phase, and cannot be freely increased, decreased or modified.
29) For the purpose of calculation, a “financial module” comprises some “auxiliary projections.” The purpose of an “auxiliary projection” is solely for facilitating the calculation of data of other “projections.” The “auxiliary projection” has no category or label, and is therefore not used for indicating the financial status of a “planning target.” A “planning target” does not need to pay attention to the existence of the “auxiliary projection”, and thus the “auxiliary projection” is an “invisible projection” for a “planning target.”
30) Methods for generating data of a “projection” and of an “auxiliary projection”
   a. Generation by formula calculation,
   b. Direct acquisition from the “projection database.”
31) The data sources for generating data of a “projection” by formula calculation include but are not limited to:
   a. LR value,
   b. LC value,
   c. Projection parameter (PAR),
   d. Corresponding data of other “projections” of the same “life component.”
32) The “LR values” are shared by all “life components” on the “life road.” There are basically three types of “LR values”: facts, expectations and assumptions. The “LR values” include but are not limited to:
   a. Facts:
      i. Age,
      ii. Gender;
   b. Expectations:
      i. Retirement age,
      ii. Return before retirement,
      iii. Return after retirement,
      iv. Expected independent age of children;
   c. Assumptions:
      i. Life expectancy,
      ii. Inflation,
      iii. Saving interest rate,
      iv. Exchange rate,
      v. Education expenses and its growth rate,
      vi. Tax rate.
33) The “LC values” are only shared by all “projections” of that “life component”, and include but are not limited to:
   a. Age,
   b. Sex,
   c. Life expectancy,
   d. Relationship start age,
   e. Relationship end age,
   f. Expected retirement age,
   g. Income/expenses growth rate,
   h. Return/discount rate,
   i. Interest rate.
34) The methods for inputting “LC values” include but are not limited to:
   a. Manual direct input in the “life component interface”,
   b. The relationship start age and the relationship end age can be dragged and dropped in the life component mode of the “timeline planning interface” to adjust the position and length of a “life component.”
35) Apart from direct input, certain “LC values” can “anchor” (or “be locked”) in a “LR value”, meaning that a value will change according to a change in the other value. For example, the “LC value” “expenses growth rate” anchors in the “LR value” inflation.
36) “Projection parameters” are the backbone of calculating “projection” data, and include but not are not limited to:
   a. Actual local annual amount (ALAA),
   b. Actual growth/return/discount rate (AGRDR),
   c. Actual from year (AFYR),
   d. Actual to year (ATYR),
   e. Actual retirement factor (RTF),
   f. Actual death factor (DHF).
37) The “projection parameters” are not generated from numbers directly input by a “planning target”, but are generated by formula calculation.
38) The “projection parameters” can be calculated from the following values.
   a. “Item value”,
   b. “Projection value”,
   c. “Projection variance.”
39) An “item” is a detail that forms a “projection.” There is no limit on the number of “items” in a “projection.” The minimum number of “items” is one, and that “item” is called “basic item.”
40) An “item” includes certain “item values.” “Item values” are data of “items” that are available to be input, and include but are not limited to:
   a. Item name,
   b. Amount,
   c. Frequency,
   d. Exchange rate,
   e. Growth/return/discount rate.
41) The methods for obtaining an “item value” include but are not limited to:
   a. Manual direct input in the “item interface”,
   b. Environmental information collected from external institutions is stored in the “environmental information database” and selected in the form of a list,
   c. Account data of a “planning target” obtained from the internet through a “customer information retriever” or by searching account record with a search engine is processed to become an “item value”, and that “item value” is stored in the “item database.”
42) “Projection values” are “projection” data available to be input, and include but are not limited to:
   a. From year (FYR),
   b. To year (TYR),
   c. Retirement factor (RTF),
   d. Death factor (DHF).
43) The methods for inputting “projection values” include but are not limited to:
   a. Manual direct input in the “projection interface”,
   b. The from year and the to year can be dragged and dropped in the projection mode of the “timeline planning interface” to adjust the position and length of a “projection.”
44) “Projection variances” are also “projection” data available to be input, and include but are not limited to:
   a. Amount variance (AVAR),
   b. Growth/return/discount variance (GRDVAR),
   c. From year variance (FYVAR),
   d. To year variance (TYVAR),
   e. Retirement factor variance (RTFVAR),
   f. Death factor variance (DHFVAR).
45) The methods for inputting “projection variances” include but are not limited to:
   a. Manual direct input in the “projection interface”,
   b. Adjusting on the “life equalizer.”
46) Certain “projection values” and “projection variances” can “anchor” in or can be locked in “LC values” of a “life component” that such “projection values” and “project variances” belong to.
47) If a “projection” comprises only one “item”, the basic formulae for calculating a “projection parameters” include but are not limited to:

| Projection parameter | Formula |
|---|---|
| Actual local annual | =Amount × Frequency × Exchange rate × |
| amount | (1 + Amount variance) |
| Actual growth rate | =Growth rate × (1 + Growth variance) |
| Actual from year | =From year × (1 + From year variance) |
| Actual to year | =To year × (1 + To year variance) |
| Actual retirement | =Retirement factor × (1 + Retirement factor |
| factor | variance) |
| Actual death factor | =Death factor × (1 + Death factor variance) |

48) If a “projection” comprises more than one “item”, the formulae for calculating “projection parameters” include but are not limited to:

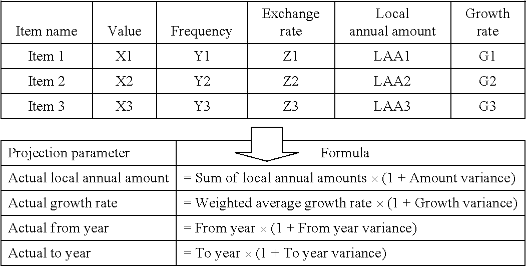

49) A “projection value” can also “anchor” in or can be locked in a “LC value” of a “life component” that the “projection value” belongs to or in a “projection parameter” of another “projection.” For instance,

| Projection parameter | Formula |
|---|---|
| Actual local annual | =Actual local annual amount (2) × Retirement |
| amount (1) | factor |
| Actual from year (1) | =Actual to year (2) |
| Actual growth rate | =Inflation |

50) All anchored or locked values can be changed to normal input values. This action is called “unanchor” or unlock.
   a. “Anchor”: Actual from year (1)=Actual to year (2)=>→
   b. “Unanchor”: Actual from year (1)=From year×(1+From year variance)
51) Data of certain “projections” are calculated by using relatively complicated methods. For example, data of the tax expenses “projection” will be calculated by the “tax calculator.”
52) Data of certain “projections”, such as the cash value “projection” of “insurance cash value”, are not suitable to be generated by calculating from “projection parameters.” Such data will be obtained directly from the “projection database.”
53) The amount variance and the growth variance are the major adjustment variables of the “life equalizer”; others in the “life equalizer” are auxiliary adjustment variables.
54) Each amount parameter or a portion of amount parameters of the life equalizer can be correlated so that they are linked in adjustment. The “life equalizer” comprises the major adjustment variances of each “projection” on the “life road.” These variances are adjusted upward or downward to achieve enhanced life planning, as shown in the “life equalizer” in FIG. 6. The two boxes in FIG. 6 show the amount variance adjustment buttons and growth variance adjustment buttons for different life components (such as self, boss, spouse, etc.) respectively. These adjustment buttons collectively form the life equalizer. The two graphs in FIG. 6 show the variance curve of the amount variance and that of the growth variance respectively. These curves can be moved from the position indicated by a dotted line to the one indicated by a solid line by adjusting the adjustment buttons of the life equalizer.
55) To simplify the operation, the amount variance and the growth variance of the “life equalizer” can be combined and in sync, i.e. change together.
56) A “stress test” can be conducted on the entire financial status of a “planning target” by adjusting the variances mentioned above. A “stress test” tests the financial tolerance of a “planning target” in a worsening situation.
57) There are two types of “stress test”:
   a. Adjusting the “projection variances” of the “life equalizer”:

| Adjustment variable | Income | Expenses | Assets | Liabilities |
|---|---|---|---|---|
| Amount variance | [symbol] | [symbol] | — | — |
| Growth variance | [symbol] | [symbol] | [symbol] (Return) | [symbol] (Interest) |
| From year variance | [symbol] | [symbol] | — | — |
| To year variance | [symbol] | [symbol] | — | — |
| Retirement factor | [symbol] | [symbol] | — | — |
| variance | | | | |
| Death factor variance | [symbol] | [symbol] | — | — |

b. Placing one or several “incidents” on the “life road” of a “planning target” to increase expenses or reduce income.
58) The “actual local annual amounts” of “begin of year 0” (BoY 0) of all projections (i.e. those with categories and labels) of all “life components” placed on the “life road” of a “planning target” will be put in the “life financial statements” of the current year of a “planning target.”
   a. All “income” of “value on living” and “available at death” and all “expenses” of “value on living” and “available at death” will be categorized according to the “categories” of the “projection”, and will be put in the form of a table in the “life cash flow statement” among financial reports.
   b. All “assets” of “value on living” and “available at death” and all “liabilities” of “value on living” and “available at death” will be categorized according to the “categories” of the “projection”, and will be put in the form of a table in the “life balance sheet” among financial reports (see FIG. 4).
59) In addition to the financial reports of the current year, the financial reports of any year (year n) can be generated according to the “actual local annual amounts” of “begin of year n” of all projections of all “life components” placed on the “life road” of a “planning target.”
60) All “life components” placed on the “life road” of a “planning target” will be categorized according to financial relationships and placed in the “financial relationships chart” of the current year of the “planning target” in the form of a chart (see FIG. 5).
61) The above specially designed “life financial statements” and “financial relationships chart” are called “financial destiny charts.”
62) The “actual local annual amounts” of the “projections” of “income” and “expenses” will be placed among annually calculated amounts in the “life cash flow statement.” Among “items” of the “projections” of “income” and “expenses”, “amounts” whose “frequency” is not once a year will be placed among monthly calculated amounts in the “life cash flow statement.”
63) “Categories” of a “projection” include:
   a. “Income” is classified according to sources, including but not limited to:
      i. Working,
      ii. Investment,
      iii. Business,
      iv. Supporting,
      v. Special;
   b. “Expenses” are classified according to purposes, and include but are not limited to:
      i. Consumption,
      ii. Capital (i.e. self-use assets),
      iii. Working,
      iv. Investment,
      v. Business,
      vi. Dependent,
      vii. Special;
   c. “Assets” are classified according to characteristics, and include but are not limited to:
      i. Saving,
      ii. Investment,
      iii. Protection,
      iv. Self-use (i.e. capital assets for living),
      v. Business,
      vi. Human,
      vii. Special;
   d. “Liabilities” are classified according to characteristics, and include but are not limited to:
      i. Consumption,
      ii. Capital (i.e. self-use assets),
      iii. Working,
      iv. Investment,
      v. Business,
      vi. Responsibility,
      vii. Special.
64) The “life financial statements” of each year can be analyzed by a conventional financial situation analysis, also called vertical analysis. The analysis includes but is not limited to:
   a. Financial position in ratios,
   b. Financial position in values,
   c. Shortfall analysis,
   d. Common size analysis.
65) As shown in FIG. 4, the “life balance sheet” among the “life financial statements” of each year can also reflect the life situation of a “planning target”, including but not limited to:
   a. Conventional assets/liabilities:
      i. Protection: Value available after death>>Value available while alive
      ii. Business: Value available after alive>>Value available after death
      iii. Self-use: Value available after death=$0
      iv. For self-use but to be sold after death: Value available after death=Value available while alive−Transaction fee
      v. Liabilities not needed to repay after death: Value liable to after death=$0
   b. Life assets/liabilities:
      i. With provider: Value available after death $0
      ii. Only myself: Value available after death=$0
      iii. The value liable to a dependent after death is not necessarily the same as the value liable to the same dependent while alive.
   c. Life situation analysis
      i. If total assets available while alive (A13)>total assets available after death (A14)→total assets not completely hedged against death risk
      ii. If total liabilities liable to while alive (L13)>total assets available while alive (A13)→life goal not likely to be realized
      iii. If total liabilities liable to while alive (L13)<total assets available after death (A14)→life value not properly used
      iv. If total liabilities liable to after death (L14)<total assets available after death (A14)→life insurance not adequate
      v. Since in the calculation of total net assets after death, the value available after death of protection assets does not need to be deducted, if the value after death of other assets can be shifted to the value available after death of protection assets, the effects of liabilities on an heir can be reduced.
      vi. Since “life value of a planning target=total life income−tax expenses−personal necessary expenses”, the life value decreases as the personal necessary expenses increase.
66) The “life financial statements” of different years can be analyzed together by a projection analysis, also called horizontal analysis. The analysis includes but is not limited to:
   a. Status quo analysis,
   b. Scenario analysis.
67) A current status analysis can be conducted on “item values” forming details of a “projection.” The analysis includes but is not limited to:
   a. Consumption and budgeting,
   b. Asset allocation,
   c. Insurance summary.
68) Data and results of analysis will be used in a financial planning report and can be fed back for adjusting “expectations” and “projection variances” of “life road values” to enhance life goals.

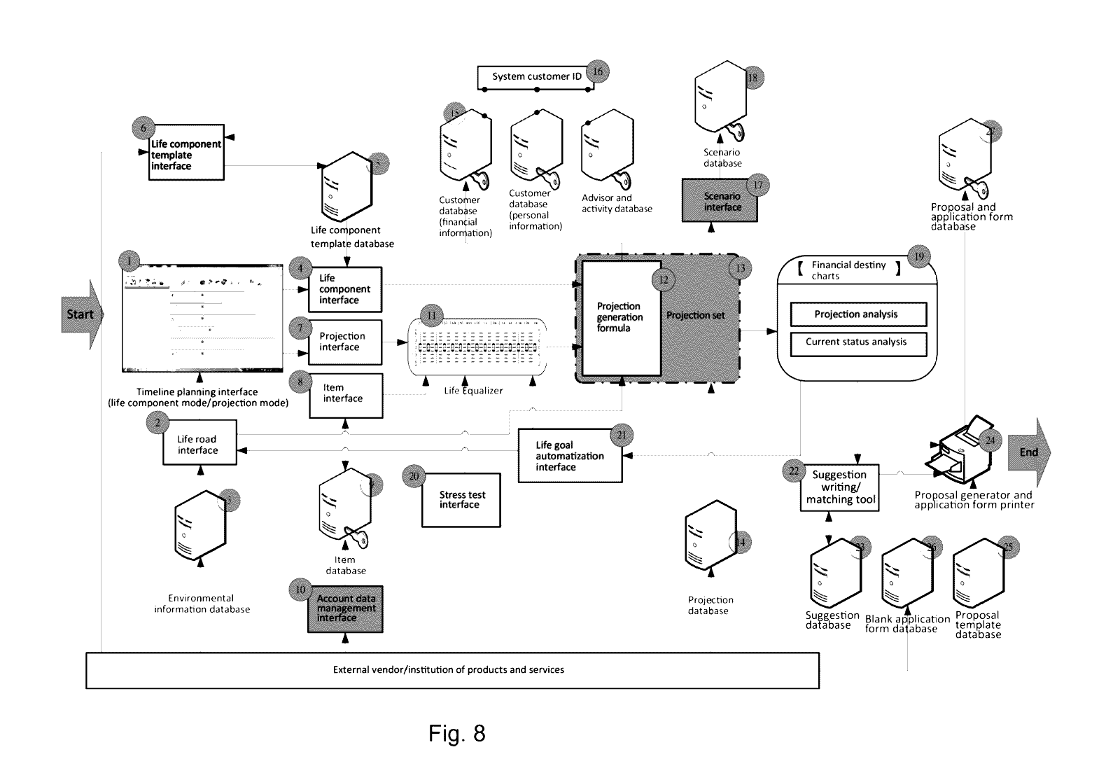

The structure and technical operation of the “life-components oriented financial planning system” of the present invention are described below with reference made to FIG. 8.
1) The “element oriented financial planning system” of the present invention starts from the “timeline planning interface.” As shown in FIG. 1, the “life components” in the “timeline planning interface” can be displayed in either “life component mode” or “projection mode.” As long as a “life component value” or a “projection life” (such as position and length) is not “anchored” or locked in another value, both modes allow a planning target to drag and drop a “life component” or an individual “projection” to adjust its position and length. A new “life component” can be dragged from the tool bar and dropped onto the life road. On the other hand, an unnecessary “life component” can also be deleted or temporarily suspended.
2) The planning target can adjust all “life road values” by accessing the “life road interface” from the “timeline planning interface.”
3) The “assumptions” of the “life road values” are generally circumstantial data, such as data of other people in the system or statistical data, can be collected from external institutions such as government departments like statistics department, insurance companies or banks, and stored in the “environmental information database.”
4) When a “life component” is dropped onto the “life road”, the “life component interface” of that “life component” appears. A planning target can on his or her own input “life component values”, “anchor” (i.e. lock) a “life component value” in a specific “life road value” or “unanchor” (i.e. unlock) a “life component value” from a specified “life road value”, or select a “life component interface” sample.
5) If a “life component interface” sample is selected, according to the selected sample, the system of the present invention will extract from the “life component template database” a “life component template” corresponding to the selection and place it in a “life component.” The “life component template database” is used for storing some default “projection values” and “item values” of a “life component.” A “template” is also called “sample.”
6) The default values can originate from data of external products, data provided by a service vendor (or an institution), or statistical data generated from the customer database (financial data) of the system of the present invention, and are sorted out in the creation interface for the “life component template.” The default values can also be directly input by a system administrator.
7) As shown in FIG. 8 and FIG. 1, the “projection interface” of each “projection” can be accessed through the “projection mode” of the “timeline planning interface.” The “projection interfaces” of all “projections” of each “life component” are accessed from the “life component mode” of that “life component.” A user can in the “projection interface” adjust all “projection values”, or “anchor” a “projection value” in a specific “life component value” or “unanchor” a “projection value” from a specific “life component value.”
8) The “item interface” of all “items in each “projection” can be accessed from the “projection interface.” A planning target can in an “item interface” add or delete “items”, and can input “item values” without a limit on the amount of “item values.”
9) All newly created “items” are stored in the “item database”, and become personal data of a planning target and are not shared with other people.
10) If a planning target allows this system to directly obtain account data of the planning target from external service vendors and external product vendors, this system can capture data from the internet, sort out the captured data in the “account data sorting interface” and store them in the “item database.” These data become personal data of a planning target and are not shared with other people.
11) The “life equalizer” is a graphical adjustment interface. FIG. 6 shows an example of “life equalizer” for amount variances and growth variances, which allows a user to adjust “financial targets” by increasing or decreasing “projection variances”, so as to balance the user's own life goals against his or her resources. Depending on the user's need, the user can set all or certain types of life component in the “life equalizer.” In addition to the direct input of numbers, this design allows the user to adjust with just a fingertip, similar to the equalizer on a stereo system, as shown in FIG. 6. This function allows a planning target to easily reshape the financial status of a customer.
12) “Projection parameters” generated from different values adjusted in the “life equalizer”, “life road values” and “life component values” are calculated by the “projection generation formulae.”
13) “Projection data” calculated by the “projection generation formulae” become the “projection set” on the “life road.”
14) Certain relatively complicated “projection data”, such as the cash value of life insurance, are not suitable to be generated by the “projection generation formulae.” In this situation, this system will extract information from data of external service vendors or external product vendors stored in the “projection database.”
15) All values on a level higher than the “projection” are stored in the “customer database (financial data)”, and become personal data of a planning target and are not shared with other people. However, statistical figures in the database can be fed back to the “life component sample creation interface” to create a suitable “life component sample” for sharing among other users.
16) All sensitive data are encrypted when transmitted on the internet. To increase security, financial information data and personal information can be stored in separate databases and linked by customer account numbers (ID) in the system, and are not to be transmitted together. This arrangement can prevent the identity of a user from being compromised even if financial data are intercepted on the internet.
17) All “projection data” in a projection set at a specific time and all values for generating “projection data” can be recorded through the “scenario interface.” The record records the scenario at a specific time, similar to taking a picture.
18) Recorded scenarios are stored in the “scenario database” so that they can be recalled for scenario analysis at any time. They are personal data of a planning target and are not shared with other people.
19) “Projection data” of a projection set can be used to create “financial destiny charts” for status analysis and projection analysis.
20) Apart from normal planning, the “stress test interface” allows a planning target” to choose to increase financial stress on the “life road”, i.e. negatively adjust the “projection variances”, in order to analyze whether the current planning can withstand increased financial stress.
21) On the other hand, according to the results of analysis mentioned above, the “life goal automatization tool” analyzes financial status and the distance to a target, and feeds back suggested changes to the “projection variances” of the “life equalizer” and the “assumptions” of the “life road interface” so that a user can refer to them.
22) After having set the financial target of a customer, a planning target can use the “suggestion writing/matching tool” to write suggestions and store them in the “suggestion database” for future use or sharing with other users.
23) If a user does not want to write a suggestion on his or her own, he or she can find a suitable suggestion in the “suggestion database.” The system can also automatically find a suitable suggestion in the database through the “suggestion editor/matcher” according to the results of analysis.
24) The “proposal generator and application form printer” can be used for generating a financial planning report/proposal for a customer, and can also create a PowerPoint presentation to brief a customer. A planning target can create a proposal of his or her own style and store it in the “proposal template database” for future use or sharing with other people.
25) A planning target can also use the templates currently stored in the “proposal template database” to quickly create a financial planning report/proposal.
26) When executing a solution, a planning target can acquire corresponding blank application forms as templates from the “blank application form database”, and automatically input data into the forms on his or her own for a customer to sign in written form or electronic form. The copies of signed application forms can also be sent to the customer by email.
27) All proposals and completed application forms can be stored in the “proposal and application form database” for a planning target to read.

The aforementioned interfaces or modules, templates, etc. of the present invention can be written as a computer program module by using a computer language or can be realized by using computer hardware modules, are suitable to be realized or displayed on devices such as desktop computers, notebook computers, tablet computers or smartphones, and can be stored in storage devices such as hard disks, CD and USB flash drives.

With regard to the business application areas of the present invention, the “life-components oriented financial planning system” of the present invention allows a financial planner to use a unique program to compete with his or her peers. Mr. Satoru Iwata, president and CEO of Nintendo Co., Ltd., producer of the world-famous Wii video game console, once said, “We are fighting not with Sony or Microsoft, but with indifference among our potential customers.” If the same idea is applied to the financial planning industry, the “life-components oriented financial planning system” of the present invention is a weapon for executing the following competition strategy: “We are fighting not with other insurance companies, banks or independent financial planners, but with indifference among our potential customers.” This can be the blue ocean strategy for the financial planning industry.

According to the observations of the present inventor, currently the market has the following existing opportunities and threats:
1. Regulatory organizations keep increasing their demand on the quality of advice provided by practitioners in the trading of financial products.
2. Customers want an integrated and comprehensive financial platform to manage personal financial information and purchased financial products that exist in different financial institutions or service-providing institutions.
3. The financial knowledge of customers keeps increasing.
4. The current commission system is being challenged, such as requests from the market for disclosure of commissions.
5. Advancements of cloud computing and rise of tablet computers.
6. The franchising platform is facing the following opportunities and challenges in China/Asia:
   a. Vertical strategy and horizontal strategy,
   b. Government's attitude,
   c. Lack of product platforms,
   d. Financial planners' expectations of owning their own business.

Depending on the size of available resources, the “life-components oriented financial planning system” of the present invention can serve the industry in one or all of the following ways.
1. The system can be used as an independent point of sales system. If used together with tablet computers and cloud computing technology, it can become a mobile point of sales technology platform for each financial institution.
2. Due to its ease of control and good interaction design, the system can be developed into a financial education platform.
3. As a franchising platform for “process”, the system can complement deficiencies in a “product” platform.
4. If its characteristic of Web 2.0 is utilized effectively, the system can be developed into an independent one-stop personal financial platform, and has a more extensive business model, such as the concept of “product placement.”

Compared with the current techniques, the “life-components oriented financial planning system” of the present invention has the following merits:
1. The life component input mode comprises mainly humanized graphical user interfaces.
2. The present invention can execute the planning process whether there are financial data of a customer at the beginning. In the course of planning, the situation the system simulates will become clearer as the customer (i.e. planning target) gives more information.
3. The system is substantially interactive and easy to control.
4. The system can execute a non-linear planning process.
5. The system has a graphical adjustment interface and a stress test interface, whereby a customer can fully control various variables and simulate hypothetical situations. A customer can understand the rationale behind the advice given by the system through concise reports that are specially designed.
6. The technological advantages of the system are mainly in target setting, financial resources adjustment and lifetime scenario analysis.

The planning interface of the present financial planning system allows a user to plan and simulate his/her own financial situations by categorization using 3 individual types of pre-modularized financial models, namely, Person, Property and Place, according to the events that the user undergo during his lifetime.

Exemplary scenarios are used to illustrate the above features:

1. Assuming a user wants to know how his financial status will be affected if he marries, i.e., a shopaholic model or actress, all he needs to do is just to drag a representative icon of the target selected from the database to the life timeline and the system will indicate how soon he will be out of cash or even bankrupted. Furthermore, advices will be given by the system on how to deal with the scenario.

2. Assuming a user wants to know whether or not his financial goals and abilities would make a good match with his fiancée, he may drag this person of interests (provided that the person of interests is a system user) to his life timeline and the system will output a series of comparison results as well as the estimated financial impact if the user marries with this person. Nevertheless, advices will be given by the system on how to solve potential problems in view of this scenario.

3. Alternatively, the system may provide a selection of fortune forecast by a series of fortune telling data imported to the system. Accordingly, the system will indicate the user's financial fortune based on the fortune telling data updated periodically.

4. In a scenario that a friend of the user requests a loan, the user may simply drag the representative icon of that person (provided that the person of interests is a system user) to the user's life timeline, then the system will provide financial advices accordingly.

5. In an event that the user considers to invest on real estates and would like to know how it can be achieved, the user may simply drag a house/apartment (where the relevant data are to be provided by relevant bodies such as real estate agencies, financial institutions and government authorities) to the user's life timeline, then the system will provide the required advices as necessary.

6. In a scenario that the user plans to furnish his newly purchased home with furniture and home appliances which the budget needs to be determined, the user may simply drag the individual items (e.g. pricing data to be provided by procurement platforms) on his life timeline, where relevant financial advices will be provided. Upon the user's confirmation to proceed, the system may provide guidance and tools for the user on purchasing the items online.

Event Triggered Advice

Another important benefit of the system of the present invention is to provide active advisory and at the same time reducing annoyance to the user to a minimum. This is done by the feature—Event Triggered Advice (ETA). Active advisory may be triggered in below situations.

1. By instant transaction via mobile payment, e.g. NFC. As the Near-Field Communication (NFC) technology become mature, users may choose to use the mobile NFC to make payments. The present system may be implemented as a mobile app installed on a mobile device, where advisory actions can be given in advance of when a payment transaction is about to be processed. For example, if the user wants to buy something rather expensive, such as luxury goods, instant advice about the financial impact of this purchasing will be given via the mobile device. If user acknowledges the consequences and insists on the purchase, payment transaction will be processed. Otherwise, he can call off the purchase before payment is made.

2. By scanning the information on personal financial account, e.g. mobile NFC record, bank or credit card, via Data Grasper. For example, if ETA scanned a series of transaction of baby food and toy purchasing, the system will guess the user might have a baby already. Then the system will give out congratulation message as well as advice on the financial impact of raising up a child.

3. By analysing the information on social media, e.g. Facebook, LinkedIn, WeChat, etc. For example, if the system scans and detects photos or conversations about wedding, active advice will be given to remind the need of family planning in the financial aspect.

4. By analysing news on media. For example, if news about a disastrous event, severe pandemic or financial crisis is acknowledged, the system may actively advice on how to deal with the associated financial risks and evaluate whether the user's counter measures are sufficient to safeguard his financial interests.

Design details of Financial Relationship Diagram (FRD)

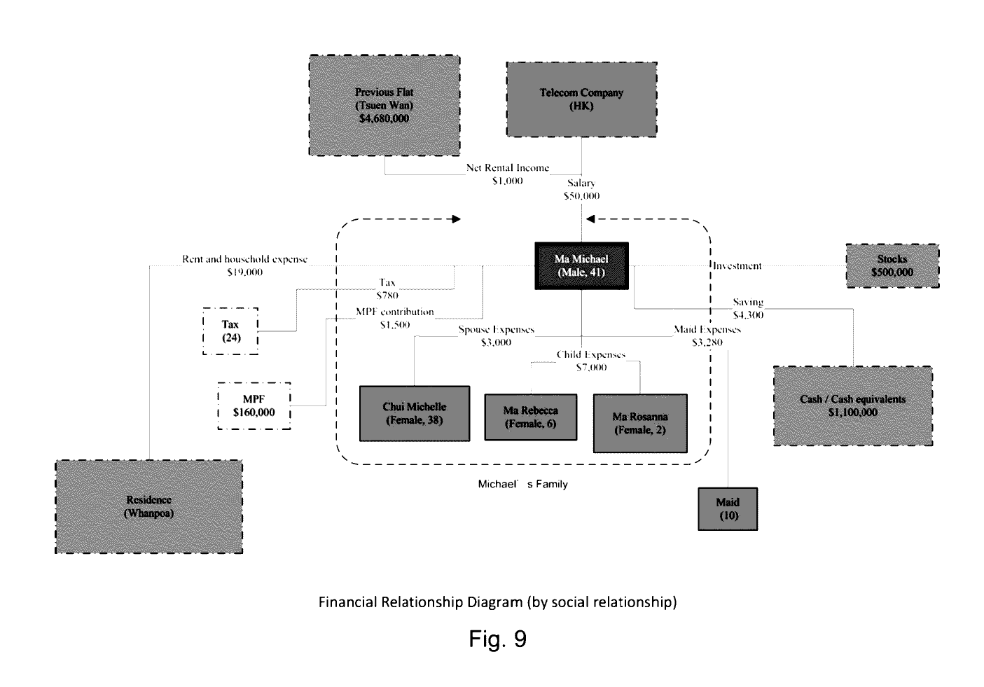

Financial Relationship Diagram is an innovative design to show one's financial situation clearly at a glance. There are two display modes of FRD, namely, by social relationship (shown in FIG. 9) or by financial relationship. Basically it is an organization chart of Person, Property and Place (3P) modules following below rules.

1. Modules display from top to below according to top-down cash flow

2. The connector display the amount and type of the cash flow

3. More important the modules, more near the client module. The importance is defined by the cash flow amount, the kind of financial relationship and the priority expressed by the client.

4. One colour tone for each category of the module, from deep to pale according to importance.

5. The size of the module according to the value of the assets or liabilities/obligations.

The principles and configurations of the present invention have been introduced above with preferred embodiments, and the above content should be construed as merely descriptive rather than restrictive. In addition, various modifications and/or alterations may be made to the present invention by those skilled in the art in view of the teachings set forth in the description, and these modifications and/or alterations shall all fall into the scope of the claims of the present invention.

1. A life-components oriented financial planning system comprising:
a timeline planning interface module for generating a timeline planning interface comprising a plurality of histograms representing life components of a user, wherein the timeline planning interface represents a timeline of the user, and the life components refer to people and events in financial association with a person that occur during a lifetime of the user;
a projection generation module comprising projection generation formulae for calculating projection data, wherein the entirety of the projection data forms a projection set of the timeline;
a financial destiny chart module used for creating financial destiny charts from projection data in the projection set, wherein the financial destiny charts comprise life financial statements and financial relationships charts; and
wherein each life component comprises eight projections divided into two groups, each of which comprises income, expenses, assets and liabilities, the timeline planning interface is displayed in a life component mode or a projection mode, and the position and length of the histogram represent a value of a corresponding life component;
the timeline of the user comprises life components; life components are grouped together by financial modules and are formed from projections; details of the projection comprise items; and the entire financial life of the user is divided into four categories: the timeline, the life component, the projection and the item.

2. The life-components oriented financial planning system according to claim 1, further comprising a life component template database, the life component template database is used for storing several default projection values and item values of a life component.

3. The life-components oriented financial planning system according to claim 1, wherein the life components are divided into three groups: the first group is people, which is based on social relationships; another group is possession, which is based on the function of a possession; the last group is incidents, referring to risk or unexpected events that occur;
wherein the life components comprise financial modules, which are divided into three types, person, property and place; the financial modules use various numbers of projections having various characteristics to depict financial characteristics of people around the user, possessions owned by the user and places of the possessions in association with the user.

4. The life-components oriented financial planning system according to claim 1, wherein the life component comprises financial modules and the financial module comprises projections of varied numbers and characteristics, and the life component comprises also projections of varied values and characteristics,
wherein projection is a series of data, and the amount of data is equivalent to the length of life of the user; and
the projection is divided into two groups, value on living group and available at death group, each of which is further divided into four categories: assets, liabilities, income and expenses, resulting in a total of eight types of projections.

5. The life-components oriented financial planning system in accordance with claim 1, wherein all life components placed on the timeline of a planning target are categorized according to financial relationships and placed in the financial relationships chart of the current year of the user in the form of a chart.

6. The life-components oriented financial planning system in accordance with claim 1, wherein actual local annual amounts of projections of income and expenses are placed in annually calculated amounts in a life cash flow statement; among items of the projections of income and expenses, amounts having a non-once-a-year frequency are placed in monthly calculated amounts in the life cash flow statement.

7. The life-components oriented financial planning system in accordance with claim 1, wherein when a life component is dropped onto the timeline represented by the timeline planning interface, the life component interface of the life component appears, in which life component values are input, a life component value is locked in or unlocked from a specific timeline value, or a life component interface template is selected.

8. A life-component oriented financial planning system comprising:
a computer stores and runs an application associated with the life-component oriented financial planning system;
a database comprising series of pre-set values; wherein the application comprises:
a plurality of life-component templates, wherein each of the templates comprises pre-set values associated with a life-component extracted from the database, wherein the life-components refer to persons or events which may be encountered by a user in his lifetime or occurred during lifetime of a user;
a timeline planning interface which generates a simulated timeline of the lifetime of the user in graphical means, the timeline planning interface allows a user to select the life-component templates in form of histograms which can be added to said timeline; and
a chart interface which displays to the user financial relationships between the selected life-components and the user on the timeline in graphical means,
wherein the user selects the life-components templates by dragging and dropping the corresponding histograms to the simulated timeline, the system indicates a financial consequence as a result of adding the selected life-components to the timeline and provides predetermined advises associates with the financial consequence.

9. The life-component oriented financial planning system according to claim 8, wherein the timeline planning interface categorizes life-components into individual pre-modularized financial models.

10. The life-component oriented financial planning system according to claim 9, wherein the pre-modularized financial models may be a person, property or a place.

11. The life-component oriented financial planning system according to claim 8, wherein the user adds a life-component which being another user of the system, the system compares and indicates a comparison and the financial consequence in an event that the two users are married.

12. The life-component oriented financial planning system according to claim 8, wherein the user adds a life-component of purchasing a real estate to the timeline, the system indicates the financial consequence of such purchase based on relevant financial data collected externally from relevant agencies or institutions.

13. The life-component oriented financial planning system according to claim 8, wherein the user adds a life-component of purchasing an item, the system provides the user the purchase options according to pricing data provided by online procurement platforms, wherein the system indicates the financial consequence of such purchase based on the user's selection of the item to be purchased.

14. A life-component oriented financial planning system comprising:
a computer stores and runs an application associated with the life-component oriented financial planning system;
a database comprising series of pre-set values; wherein the application comprises:
a plurality of life-component templates, wherein each of the templates comprises pre-set values associated with a life-component extracted from the database, wherein the life-components refer to persons or events which may be encountered by a user in his lifetime or occurred during lifetime of a user;
a timeline planning interface which generates a simulated timeline of the lifetime of the user in graphical means, the timeline planning interface allows a user to select the life-component templates in form of histograms which can be added to said timeline; and
a chart interface which displays to the user financial relationships between the selected life-components and the user on the timeline in graphical means,
wherein the user selects the life-components templates by dragging and dropping the corresponding histograms to the simulated timeline, the system indicates a financial consequence as a result of adding the selected life-components to the timeline and provides predetermined advises associates with the financial consequence, and
wherein the computer is a mobile device and the life-components oriented financial planning system being implemented as a mobile application to be used with the mobile device, the system further comprises an event triggered advisory module, the event triggered advisory module provides active advisory when an occurrence of a predetermined event is logged by the system.

15. The life-component oriented financial planning system according to claim 14, wherein the timeline planning interface categorizes life-components into individual pre-modularized financial models.

16. The life-component oriented financial planning system according to claim 15, wherein the pre-modularized financial models may be a person, property or a place.

17. The life-components oriented financial planning system according to claim 14, wherein the predetermined event is an electronic payment transaction via Near-Field Communication, upon the occurrence of the pre-determined event, the system triggers an action by prompting the user about the financial impact of such purchase, and the system provides options for the user whether to proceed or abort the purchase.

18. The life-components oriented financial planning system according to claim 14, wherein the system accesses financial records of the user and detects a pre-determined event has occurred, the system triggers an action by prompting the user about the financial impact of such event being occurred.

19. The life-components oriented financial planning system according to claim 14, wherein the system accesses social media accounts of the user and detects a pre-determined event has occurred by scanning relevant keywords or photographs, the system triggers an action by prompting the user about the financial impact of such event being occurred.

20. The life-components oriented financial planning system according to claim 14, wherein the system accesses the news media in real time and detects a pre-determined event has occurred, the system triggers an action by prompting the user about the financial impact of such event being occurred and providing appropriate actions to be taken by the user to mitigate lost.
